(19) United States
(12) Patent Application Publication
(10) Pub. No.: US 2026/0264410 A1
(43) Pub. Date: Sep. 10, 2026

(54) INK REPLENISHMENT SYSTEM

(71) Applicant: SEIKO EPSON CORPORATION, Tokyo (JP)

(72) Inventors: Yuta KOIKE, Matsumoto-shi (JP); Tadahiro MIZUTANI, Shiojiri-shi (JP); Tadashi WATANABE, Matsumoto-shi (JP); Takumi NAGASHIMA, Matsumoto-shi (JP)

(73) Assignee: SEIKO EPSON CORPORATION, Tokyo (JP)

(21) Appl. No.: 19/560,306

(22) Filed: Mar. 9, 2026

(30) Foreign Application Priority Data
Mar. 10, 2025 (JP) 2025-037629

(51) Int. Cl. B41J 2/175

(52) U.S. Cl. CPC B41J 2/17509; B41J 2/17513; B41J 2/17523; B41J 2/17596

(57) ABSTRACT

An ink replenishment system includes a printer having an ink introduction member and an ink replenishment container. The ink replenishment container includes an ink accommodating portion, an ink outlet forming portion, and a valve, the valve including a seal member, a valve body, and an elastic member. In a valve-open state, the valve body is pushed by the ink introduction member inserted into the ink outlet forming portion to be separated from the seal member, and in a valve-closed state, the valve body comes into contact with the seal member by removal of the ink introduction member . The seal member has a first locking portion, the ink introduction member has a second locking portion, and the first locking portion and the second locking portion are engaged with each other in the valve-open state to restrict the ink replenishment container from moving relative to the ink introduction member.

### CROSS REFERENCE RELATED APPLICATIONS

The present application is based on, and claims priority from JP Application Serial Number 2025-037629, filed Mar. 10, 2025, the disclosure of which is hereby incorporated by reference herein in its entirety.

### BACKGROUND

### 1. Technical Field

The present disclosure relates to an ink replenishment system.

### 2. Related Art

JP-A-2023-43905 discloses an ink replenishment container which is connected to an ink inlet flow path member in an inverted orientation to replenish ink to a printer. The ink replenishment container is provided with an outlet valve unit having a valve body and a spring member in an ink outlet. In the ink replenishment container before being mounted on the printer, the spring member biases the valve body in a direction in which the valve body is closed. When the ink replenishment container is mounted on the printer, the ink inlet flow path member connected to the ink replenishment container pushes the valve body against the biasing force of the spring member, whereby the valve body is opened and the ink is replenished. During the ink replenishment, a seal member disposed at the ink outlet of the ink replenishment container comes into contact with the outer circumferential surface of the ink inlet flow path member to seal the ink inlet flow path member so that the ink does not leak to the outside.

However, in a case where the biasing force of theelastic member which biases the valve body such that the valve is closed is large, there is a possibility that the ink replenishment container moves in a direction away from the ink introduction member of the printer during the ink replenishment due to the biasing force of the elastic member. As a result, there is a possibility that a decrease in the ink replenishment amount, an increase in the ink replenishment time, or the like occurs, and there is room for improvement in convenience for the user.

### SUMMARY

A first aspect of the present disclosure provides an ink replenishment system including: a printer including an ink reservoir and an ink introduction member communicating with the ink reservoir; and an ink replenishment container for replenishing ink to the ink reservoir of the printer via the ink introduction member. The ink replenishment container includes: an ink accommodating portion configured to accommodate ink; an ink outlet forming portion in fluid communication with the ink accommodating portion and having an outlet on an opposite side from the ink accommodating portion; and a valve disposed in the ink outlet forming portion, the valve including a seal member located on a side closer to the outlet, a valve body, and an elastic member that biases the valve body toward the seal member in a first direction to bring the valve body into contact with the seal member, wherein, in a valve-open state of the valve, the valve body is pushed in a second direction opposite to the first direction by the ink introduction member inserted into the ink outlet forming portion to be separated from the seal member, and in a valve-closed state of the valve, the valve body comes into contact with the seal member upon the ink introduction member being removed from the ink outlet forming portion, and wherein the seal member has a first locking portion, the ink introduction member has a second locking portion, and the first locking portion and the second locking portion are engaged with each other in the valve-open state to restrict the ink replenishment container from moving in the second direction relative to the ink introduction member.

### BRIEF DESCRIPTION OF THE DRAWINGS

FIG. 1 is a perspective view of a printer.

FIG. 2 is a perspective view of an ink reservoir.

FIG. 3 is a side view of an ink introduction member.

FIG. 4 is a perspective view showing a state in which ink is replenished to the ink reservoir by using an ink replenishment container.

FIG. 5 is an exploded perspective view of the ink replenishment container.

FIG. 6 is a first perspective view of a valve.

FIG. 7 is a second perspective view of the valve.

FIG. 8 is a view showing a configuration of a valve body.

FIG. 9 is a partial cross-sectional view of the ink replenishment container and the ink reservoir in a replenishment state.

FIG. 10 is an enlarged view of a part of FIG. 9.

FIG. 11 is a partial cross-sectional view of the ink replenishment container in a non-replenishment state.

FIG. 12 is an enlarged view of a part of FIG. 11.

FIG. 13 is a side view of an ink introduction member in a second embodiment.

FIG. 14 is a side view of an ink introduction member in a third embodiment

FIG. 15 is a side view of an ink introduction member in a fourth embodiment.

FIG. 16 is a partial cross-sectional view of an ink replenishment container and an ink reservoir in a valve- open state in the fourth embodiment.

### DESCRIPTION OF EMBODIMENTS

### A. First Embodiment:

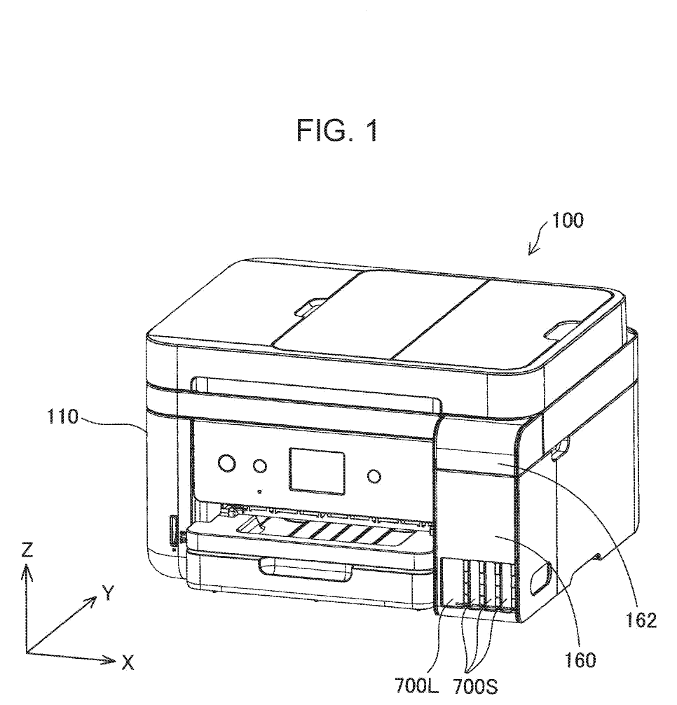

FIG. 1 is a perspective view of a printer 100. The printer 100 is an ink jet printer that ejects ink onto a print medium to perform printing. In FIG. 1, X-, Y-, and Z- axes orthogonal to each other are illustrated. The X-axis corresponds to a width direction of the printer 100, the Y- axis corresponds to a depth direction of the printer 100, and the Z-axis corresponds to a height direction of the printer 100. The printer 100 is installed on a horizontal installation surface defined by an X direction and a Y direction. Note that the "X direction" is a direction along the X-axis and means a concept including both a +X direction and a -X direction. Similarly, the "Y direction" is a direction along the Y-axis and means a concept including both a +Y direction and a -Y direction, and a "Z direction" is a direction along the Z-axis and means a concept including both a +Z direction which is a vertically upward direction and a -Z direction which is a vertically downward direction.

The printer 100 includes a housing 110. The housing 110 houses a carriage (not shown) movable in the X direction, which is a main scanning direction. A print head that ejects ink onto a print medium is installed in the carriage. An ink reservoir accommodating unit 160 that accommodates a plurality of ink reservoirs 7005 and 700L is provided at one end of the front surface of the housing 110. The ink reservoir accommodating unit 160 has a lid 162 which can be opened and closed at an upper portion thereof. The ink reservoirs 7003 and 700L are ink tanks. The ink reservoir 7003 is a small-capacity tank, and the ink reservoir 700L is a large-capacity tank. However, in the following description, both the ink tanks are not distinguished from each other and are simply referred to as "ink reservoir 700". Each ink reservoir 700 is connected to the print head of the carriage by a tube (not shown). That is, the ink reservoir 700 is a stationary ink tank which is not mounted on the carriage of the printer 100. Further, each of the ink reservoirs 700 is an ink tank of an ink replenishment type in which ink is replenished from an ink replenishment container when the remaining amount of ink decreases. The ink reservoir 700 in the present disclosure is not limited to a stationary ink tank, and may be an ink tank mounted on a carriage of the printer 100.

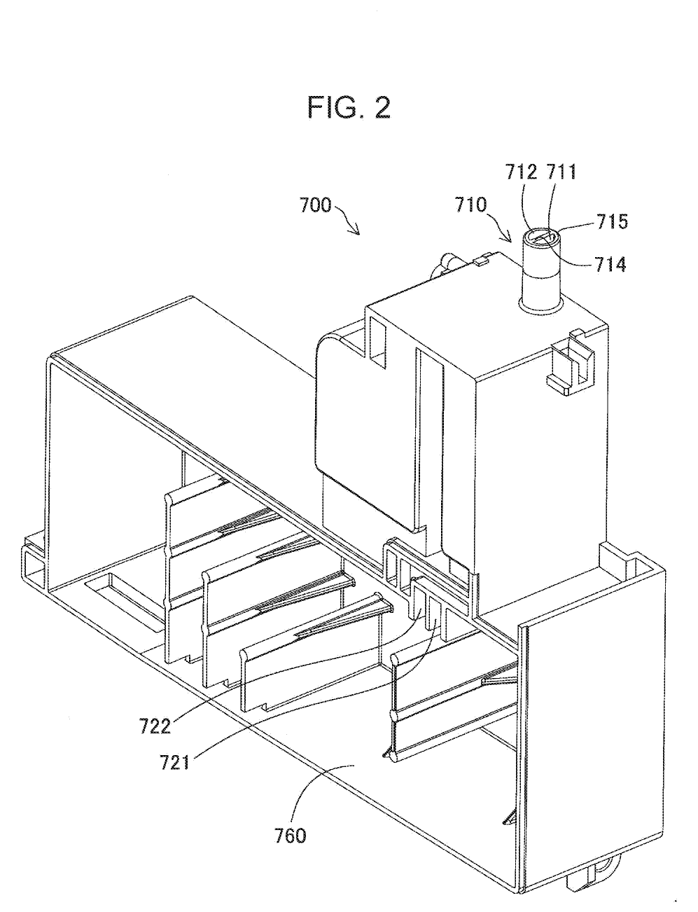

FIG. 2 is a perspective view of the ink reservoir 700. An ink introduction member 710 for replenishing ink to the ink reservoir 700 is provided on the upper surface of the ink reservoir 700. The ink introduction member 710 is a tubular member protruding upward from the ink reservoir 700. The ink introduction member 710 has a plurality of introduction flow paths 711 and 712 partitioned by a partition 714. In the present embodiment, the ink introduction member 710 has two introduction flow paths 711 and 712. The two introduction flow paths 711 and 712 respectively communicate with two in-tank flow paths 721 and 722 that protrude into an ink accommodating chamber 760 of the ink reservoir 700. A part of a tip end surface 715 of the ink introduction member 710 corresponds to an end portion of the partition 714.

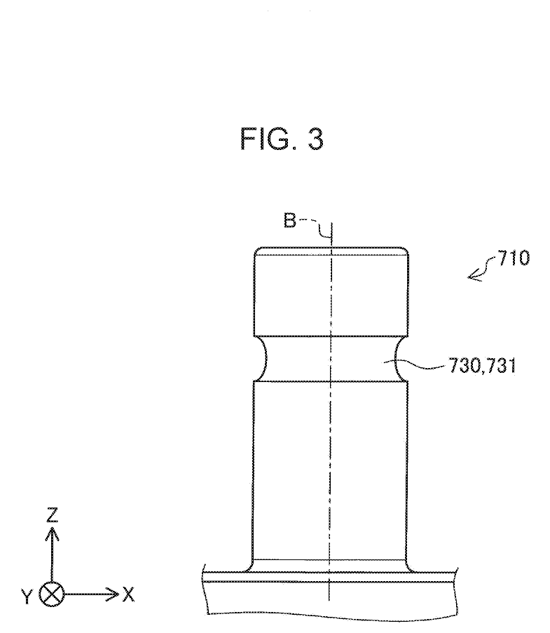

FIG. 3 is a side view of the ink introduction member 710. The ink introduction member 710 includes a second locking portion 730. In the present embodiment, the second locking portion 730 is a groove 731 provided over the entire circumference in the circumferential direction on the outer circumferential surface of the ink introduction member 710. The shape of the groove 731 in a cross section taken along a central axis B of the ink introduction member 710 is a semicircular shape. Specifically, the shape in the cross section taken along the central axis B of the portion cut out from the outer circumferential surface of the ink introduction member 710 in the portion where the groove 731 is not formed toward the central axis B is a semicircular shape. The second locking portion 730 engages with a first locking portion 512 of the ink replenishment container 200 to be described later when the ink is replenished to the ink reservoir 700 via the ink introduction member 710.

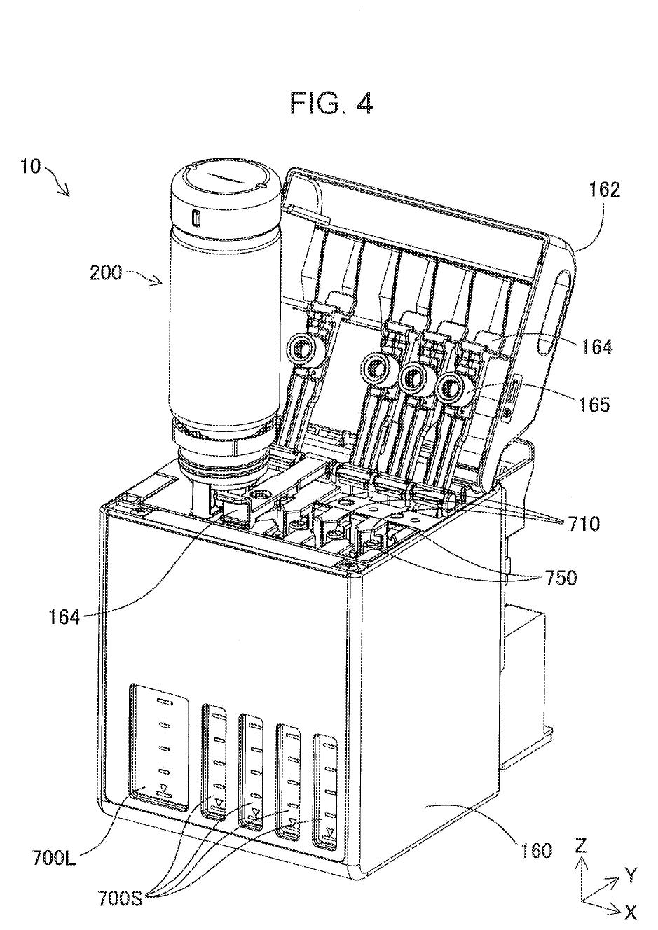

FIG. 4 is a perspective view showing a state in which ink is replenished to the ink reservoir 700 using the ink replenishment container 200. The front surface of each ink reservoir 700 is formed of a transparent member, and the amount of ink remaining in each ink reservoir 700 can be viewed from the outside. When the remaining amount of ink is low, the user can open the lid 162 and replenish ink from the ink introduction member 710 to the ink reservoir 700, as shown in FIG. 4. In the present disclosure, a system including the printer 100 and the ink replenishment container 200 is referred to as an ink replenishment system 10.

The ink reservoir accommodating unit 160 is provided with sealing cap members 164 each having a sealing cap 165 for sealing the tip of the ink introduction member 710. In a state where the ink is not replenished to the ink reservoir 700, the tip of the ink introduction member 710 is sealed by the sealing cap 165. When the ink is replenished to the ink reservoir 700, the sealing cap member 164 is removed from the ink introduction member 710, and the leading end portion of the ink replenishment container 200 is inserted at the position of the ink introduction member 710. On the periphery of the ink introduction member 710, two recessed portions 750 which are fitted to fitting portions 450 (described later) of the ink replenishment container 200 are provided. The two recessed portions 750 have a 180-degree rotationally symmetrical shape about the ink introduction member 710.

In this specification, the term "ink replenishment" means an operation of increasing the remaining amount of ink by supplying ink to the ink reservoir 700. However, it is not necessary to fill up the ink reservoir 700 with ink by the "ink replenishment". In addition, the "ink replenishment" also includes an operation of filling the empty ink reservoir 700 with ink at the time of first use of the printer 100.

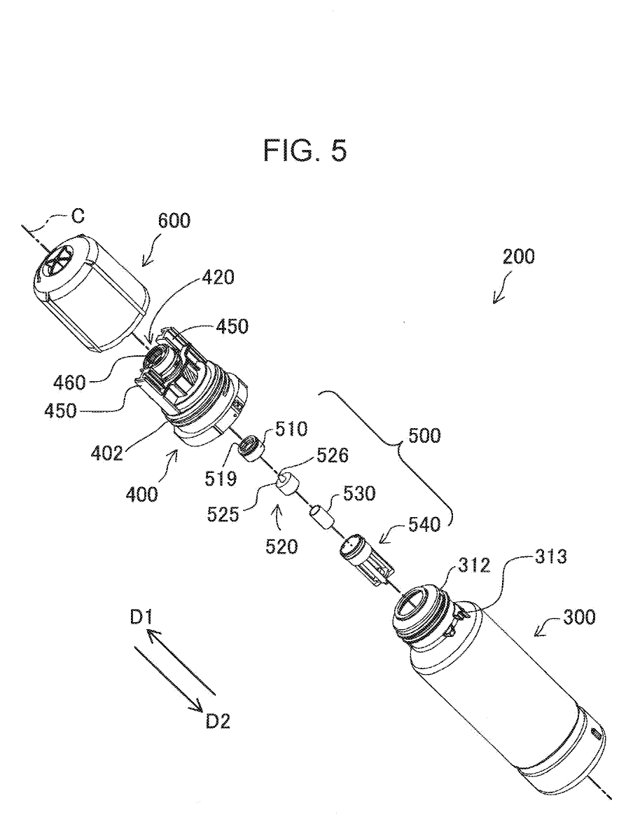

FIG. 5 is an exploded perspective view of the ink replenishment container 200. As shown in FIG. 5, the ink replenishment container 200 includes an ink accommodating portion 300, an ink outlet forming portion 400, a valve 500, and a cap 600 configured to be attachable to and detachable from the ink outlet forming portion 400. The ink replenishment container 200 has a central axis C.

Hereinafter, the cap 600 side of the ink replenishment container 200 is referred to as an "upper end side" or a "leading end side", and the ink accommodating portion 300 side is referred to as a "lower end side" or a "trailing end side". In addition, a direction along the central axis C of the ink replenishment container 200, that is, a direction parallel to the central axis C is referred to as an "axial direction", and a direction orthogonal to the axial direction is referred to as a "radial direction". A direction from the trailing end side toward the leading end side in the axial direction is referred to as a "first direction D1". A direction opposite to the first direction D1 is referred to as a "second direction D2".

The ink accommodating portion 300 is configured to accommodate ink. The ink accommodating portion 300 is a hollow cylindrical container having an opening on the leading end side. An external thread 312 for attaching the ink outlet forming portion 400 is provided in a small- diameter portion at the tip of the ink accommodating portion 300.

The ink outlet forming portion 400 is connected to the leading end side of the ink accommodating portion 300. The ink outlet forming portion 400 is in fluid communication with the ink accommodating portion 300 in a state of being connected to the ink accommodating portion 300. The ink outlet forming portion 400 has the same central axis C as the ink replenishment container 200. On the inner side of the ink outlet forming portion 400, an internal thread (not shown) to be screwed with the external thread 312 of the ink accommodating portion 300 is provided. On the outer side of the ink outlet forming portion 400, an external thread 402 for attaching the cap 600 is provided. Further, teeth (not shown) constituting one of two parts of a ratchet mechanism are provided on the inner circumference of the trailing end portion of the ink outlet forming portion 400. On the trailing end side of the external thread 312 of the ink accommodating portion 300, a claw 313 which constitutes the other one of the two parts of the ratchet mechanism and engages with the teeth is provided. The ratchet mechanism has a function of restricting rotation in a direction opposite to the direction in which the internal thread of the ink outlet forming portion 400 and the external thread 312 of the ink accommodating portion 300 are screwed together. This ratchet mechanism reduces the likelihood that the ink outlet forming portion 400 rotates together with the cap 600 and comes off from the ink accommodating portion 300 when the user unscrews and removes the cap 600 from the external thread 402.

An ink outlet 460 is provided at the tip of the ink outlet forming portion 400. The ink outlet forming portion 400 is connected to the ink accommodating portion 300 and includes a tubular portion 420 having the ink outlet 460. The valve 500 is attached into the tubular portion 420. In other words, the valve 500 is disposed inside the ink outlet forming portion 400. Therefore, the valve 500 can be regarded as a member forming a part of the ink outlet forming portion 400. When ink is replenished to the ink reservoir 700 of the printer 100, the ink introduction member 710 of the ink reservoir 700 is inserted into the ink outlet 460. The ink outlet 460 is formed in a cylindrical shape so that the ink introduction member 710 is inserted thereinto. The ink outlet 460 is also simply referred to as an outlet.

On the periphery of the ink outlet 460, the two fitting portions 450 are provided. These fitting portions 450 are positioning members for positioning the ink replenishment container 200 by being fitted into the recessed portions 750 provided on the periphery of the ink introduction member 710 of the ink reservoir 700. The positioning is, for example, at least one of a function of preventing erroneous pouring of ink by fitting the ink replenishment container 200 for replenishing yellow ink into the recessed portions 750 corresponding to the ink reservoir 700 accommodating yellow ink and preventing the ink replenishment container 200 for replenishing ink of other colors such as magenta ink and cyan ink from being fitted thereinto, and a function of stabilizing the ink pouring orientation of the ink replenishment container 200. The function of preventing erroneous ink pouring is to prevent not only erroneous pouring of a different color ink but also, for example, in the case of black ink, erroneous pouring between dye-based black ink and pigment-based black ink. The two fitting portions 450 have a 180-degree rotationally-symmetrical shape about the central axis C of the ink replenishment container 200. At the time of ink replenishment, the fitting portions 450 of the ink replenishment container 200 are fitted into the recessed portions 750 provided on the periphery of the ink introduction member 710 of the ink reservoir 700, whereby the orientation of the ink replenishment container 200 is limited to two orientations that are 180-degree rotationally-symmetric. Thus, the ink replenishment container 200 can remain in a stable orientation during ink replenishment. However, the fitting portions 450 may be omitted. In addition, to "fit" includes loosely fitting through a slight gap.

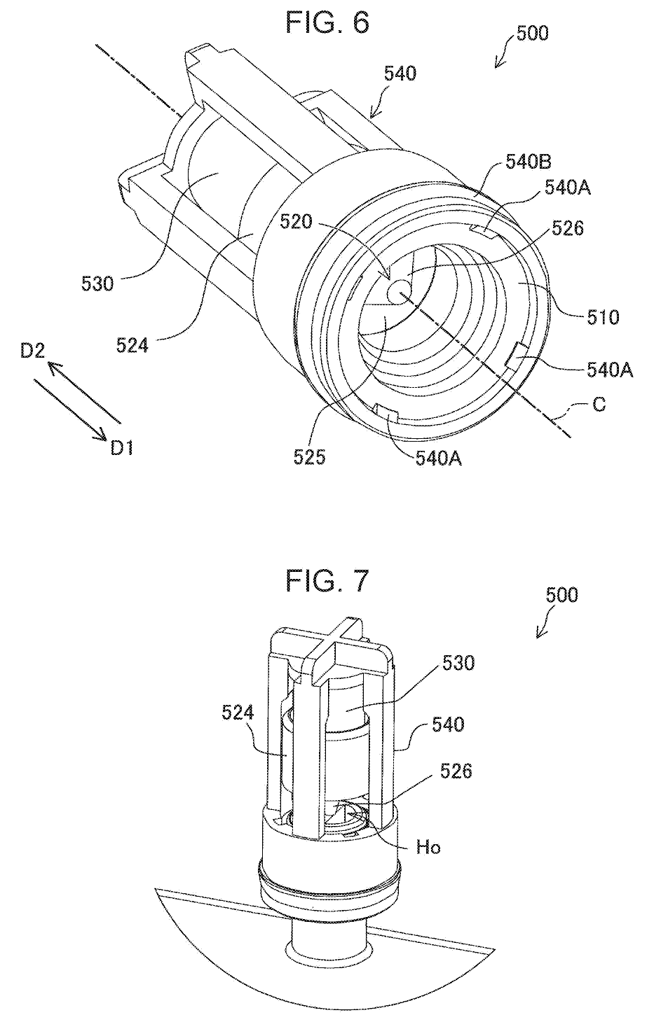

FIG. 6 is a first perspective view of the valve 500. FIG. 7 is a second perspective view of the valve 500. FIG. 7 shows a state in which the ink introduction member 710 is inserted into the ink outlet 460. As shown in FIGS. 5 to 7, the valve 500 includes a valve housing 540, an elastic member 530, a valve body 520, and a seal member 510.

The valve housing 540 accommodates the elastic member 530, the valve body 520, and the seal member 510 therein. The valve housing 540 has a substantially cylindrical shape in which an end portion on the leading end side in the axial direction is open and an end portion on the trailing end side in the axial direction is closed. The ink introduction member 710 can be inserted into and removedfrom the valve housing 540 through an opening formed on the leading end side. The valve housing 540 is attached inside the tubular portion 420 so as to provide a gap in the radial direction between the valve housing 540 and the tubular portion 420. As shown in FIG. 6, on the leading end side, the valve housing 540 has retaining portions 540A for reducing the likelihood that the seal member 510 comes off from the valve housing 540 and an engaging portion 540B for engaging with the tubular portion 420. As shown in FIG. 7, the valve housing 540 has a through hole Ho. The through hole Ho is a hole that extends through the side wall of the valve housing 540 in the radial direction, and is formed so as to extend also in the axial direction. The through hole Ho communicates with a radial gap between the valve housing 540 and the tubular portion 420.

The elastic member 530 is accommodated in thevalve housing 540 and supported by the valve housing 540. The elastic member 530 is accommodated on the trailing end side in the axial direction in the valve housing 540. The elastic member 530 is made of, for example, metal. In the present embodiment, the elastic member 530 is a coil spring. The elastic member 530 biases the valve body 520 in the first direction D1.

The valve body 520 is disposed to be movable in the axial direction in the valve housing 540. The valve body 520 is accommodated in the valve housing 540 further on the leading end side than the elastic member 530 in the axial direction. The valve body 520 is formed of, for example, a thermoplastic resin such as polyethylene or polypropylene.

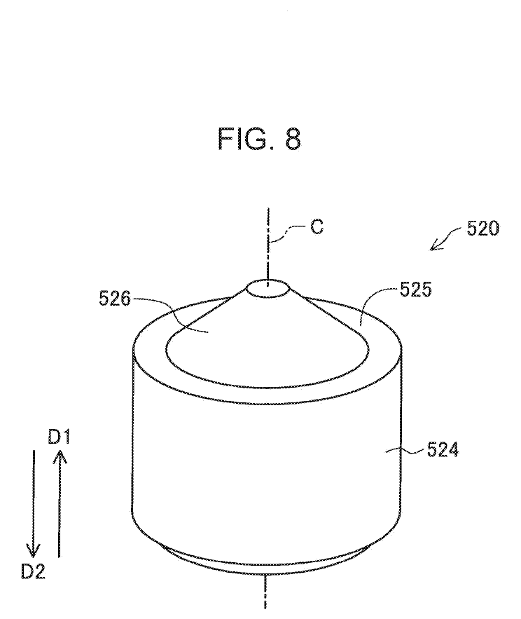

FIG. 8 is a view showing a configuration of the valve body 520. The valve body 520 has a cylindrical portion 524, a seal surface 525, and a protrusion 526.

The cylindrical portion 524 has a cylindrical shape extending in the axial direction. The cylindrical portion 524 faces the inner surface of the valve housing 540. The cylindrical portion 524 is slidable in the axial direction by being guided by the inner surface of the valve housing 540.

The seal surface 525 is formed on an end surface located on the first direction D1 side of the cylindrical portion 524. The seal surface 525 extends in the radial direction of the cylindrical portion 524. The seal surface 525 has an annular shape when viewed along the axial direction.

The protrusion 526 is formed further inside in the radial direction of the cylindrical portion 524 than the seal surface 525. The protrusion 526 is located further on the ink outlet 460 side than the seal surface 525 in the axial direction. The shape of the protrusion 526 is a truncated conical shape in which the cross-sectional area in the radial direction is larger on the second direction D2 side than on the first direction D1 side.

The seal member 510 is attached inside the valve housing 540. The seal member 510 is located further on the leading end side in the axial direction than the valve body 520 in the valve housing 540. The seal member 510 is substantially ring-shaped. The seal member 510 is formed of, for example, an elastic rubber member or an elastomer. The seal member 510 has a through hole 519 which extends through the seal member 510 in the axial direction and into and from which the ink introduction member 710 is inserted and removed. The through hole 519 is formed by an inner circumferential surface of the seal member 510. The central axis of the through hole 519 coincides with the central axis C of the ink replenishment container 200.

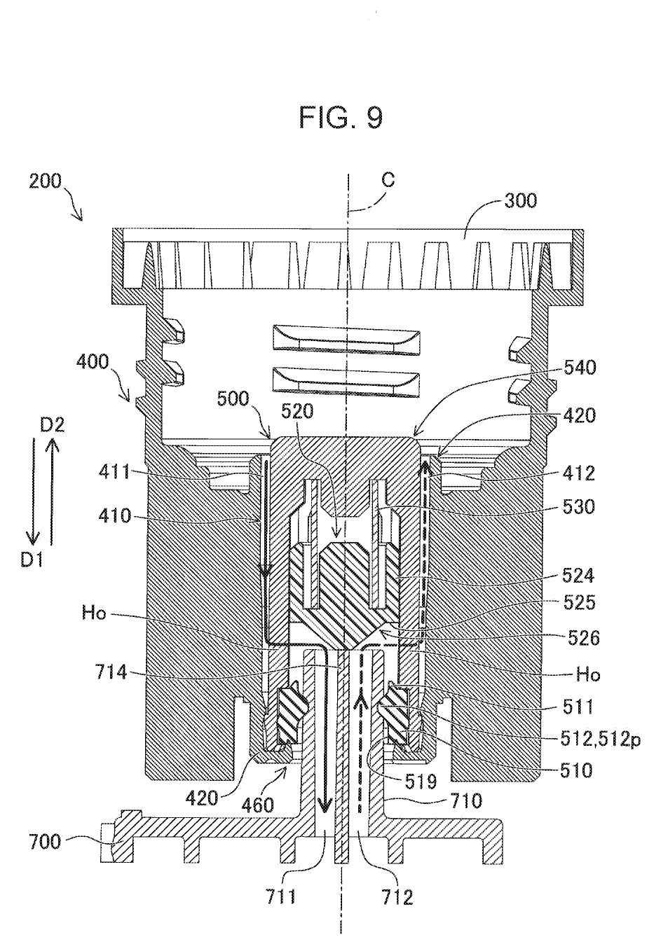

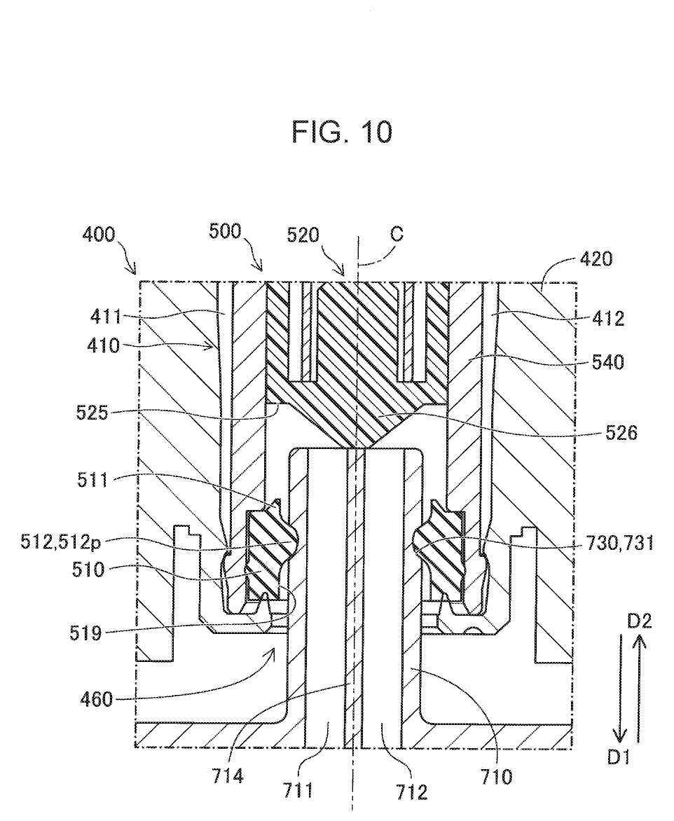

FIG. 9 is a partial cross-sectional view of the ink replenishment container 200 and the ink reservoir 700 in a replenishment state in which ink is replenished to the ink reservoir 700. FIG. 9 shows a cross section of a part of the configuration of the ink replenishment container 200 and a part of the configuration of the ink introduction member 710 when cut along the central axis C. FIG. 10 is an enlarged view of a part of FIG. 9. In the replenishment state, the ink replenishment container 200 is in an inverted orientation. In the replenishment state, the valve 500 is in a valve-open state in which the sealing of the ink outlet 460 is released so that the ink flows into the ink introduction member 710. In the valve-open state of the valve 500, the valve body 520 is pushed toward the second direction D2 by the ink introduction member 710 inserted into the ink outlet forming portion 400 to be separated from the seal member 510. In the valve-open state, the partition 714 of the ink introduction member 710 comes into contact with the tip of the protrusion 526 of the valve body 520.

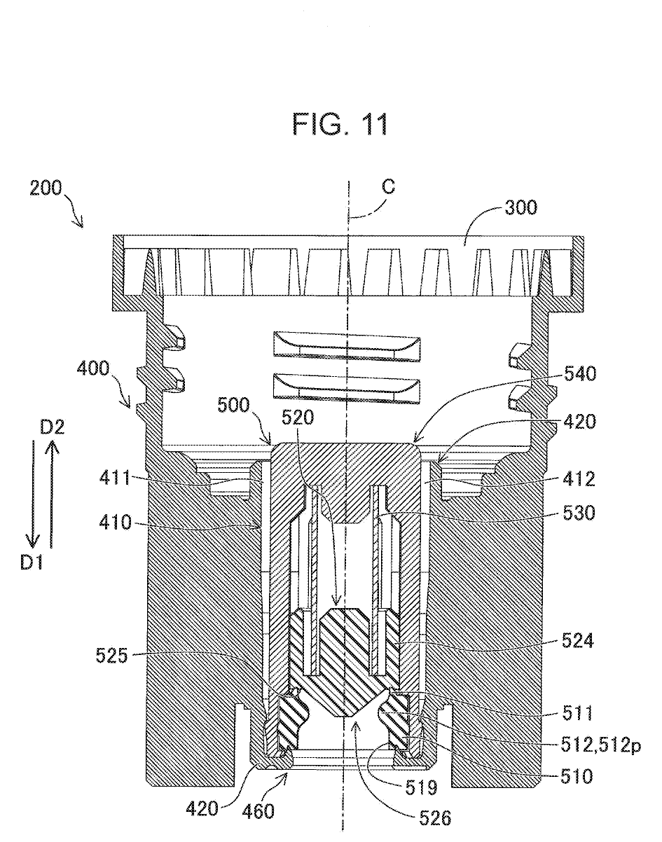

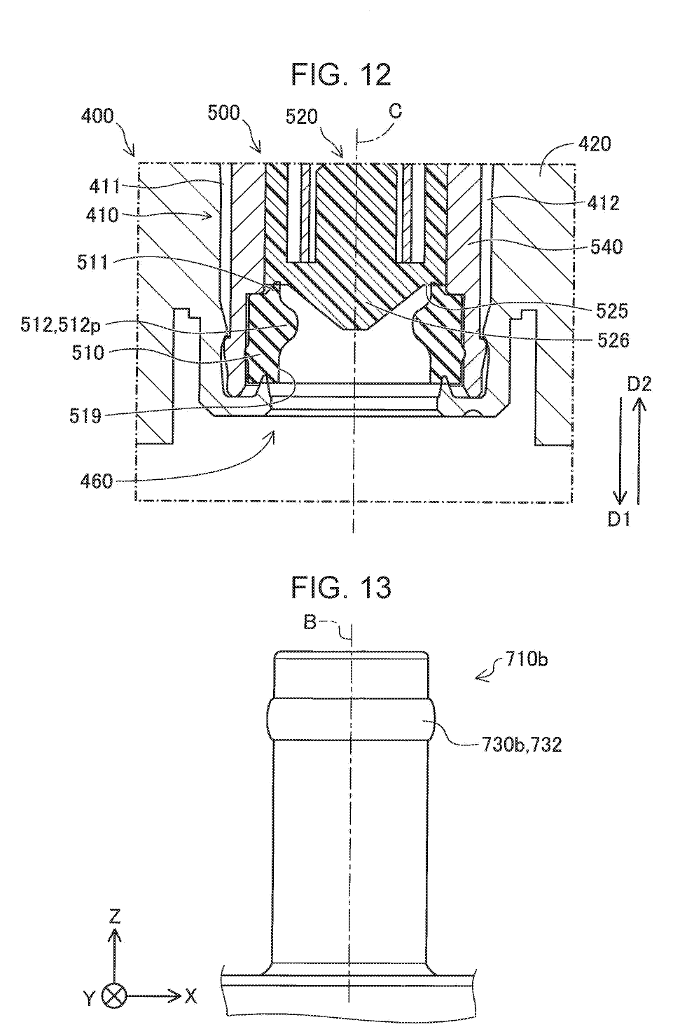

FIG. 11 is a partial cross-sectional view of the ink replenishment container 200 in a non-replenishment state in which ink is not replenished to the ink reservoir 700. FIG. 11 shows a cross section of a part of the configuration of the ink replenishment container 200 cut along the central axis C. FIG. 12 is an enlarged view of a part of FIG. 11. In the non-replenishment state, the valve 500 is in a valve- closed state in which the ink outlet 460 is sealed so that the ink in the ink accommodating portion 300 does not leak to the outside. In the valve-closed state of the valve 500, the ink introduction member 710 is removed from the ink outlet forming portion 400, and thus the valve body 520 comes into contact with the seal member 510.

As shown in FIGS. 9 and 11, the ink outlet forming portion 400 further includes a tubular flow path portion 410. The tubular flow path portion 410 is configured as a flow path space inside the tubular portion 420. As shown in FIG. 9, the ink introduction member 710 is inserted into the tubular flow path portion 410 via the through hole 519 of the seal member 510. The tubular flow path portion 410 has a plurality of replenishment flow paths. In the present embodiment, the tubular flow path portion 410 has two replenishment flow paths 411 and 412. Each of the two replenishment flow paths 411 and 412 is formed by a gap between the inner circumferential surface of the tubular portion 420 and the outer circumferential surface of the valve 500. In the valve-open state, the protrusion 526 of the valve body 520 is pushed by the ink introduction member 710, and the valve body 520 moves in the second direction D2, whereby the introduction flow paths 711 and 712 of the ink introduction member 710 communicate with the replenishment flow paths 411 and 412, respectively, via the through hole Ho. One of the two replenishment flow paths 411 and 412 is used as an ink flow path, and the other is used as an air flow path. In FIG. 9, the solid line arrows indicate a flow of the ink, and the broken line arrows indicate a flow of air. In the present embodiment, a first replenishment flow path 411 is used as the ink flow path. A second replenishment flow path 412 is used as the air flow path.

As shown in FIGS. 10 and 12, the seal member 510 has a seal end portion 511 and the first locking portion 512.

The seal end portion 511 is formed at an end portion of the seal member 510 on the second direction D2 side. The seal end portion 511 protrudes toward the seal surface 525 of the valve body 520 along the central axis C. The seal end portion 511 switches communication between the replenishment flow paths 411 and 412 and the introduction flow paths 711 and 712. As shown in FIGS. 11 and 12, in the valve-closed state of the valve 500, the valve body 520 is biased by the elastic member 530 toward the seal member 510 located further on the ink outlet 460 side than the valve body 520. The seal end portion 511 is biased by the elastic member 530 to come into contact with the seal surface 525 of the valve body 520 in the valve-closed state of the valve 500, thereby closing the through hole 519. Accordingly, the seal end portion 511 blocks the communication between the replenishment flow paths 411 and 412 and the introduction flow paths 711 and 712. On the other hand, as shown in FIGS. 9 and 10, when the ink introduction member 710 is inserted into the tubular portion 420 from the ink outlet 460 and the valve body 520 is pressed in the second direction D2, the seal end portion 511 is separated from the seal surface 525 of the valve body 520. Thus, in the valve-open state of the valve 500, a gap is formed between the seal end portion 511 and the valve body 520. In other words, in the valve-open state of the valve 500, the ink introduction member 710 is inserted through the through hole 519 and presses the valve body 520 in the second direction D2. Thus, a gap through which ink and air flow is formed between the seal member 510 and the valve body 520. In addition, in the valve-closed state of the valve 500, when the ink introduction member 710 is removed through the through hole 519, the valve body 520 comes into contact with the seal member 510 to close the through hole 519.

The first locking portion 512 is formed on the inner circumferential surface of the seal member 510. The first locking portion 512 comes into contact with the side surface of the ink introduction member 710 inserted into the through hole 519 in the valve-open state to seal the through hole 519. In the present embodiment, the first locking portion 512 is a first protruding portion 512p which is provided along the circumferential direction of the inner circumferential surface of the seal member 510 forming the through hole 519 and protrudes toward the central axis C. The first protruding portion 51²p is a sealing portion which comes into contact with the outer circumferential surface of the ink introduction member 710 inserted into the through hole 519 over the entire circumference in the circumferential direction in the valve-open state. That is, in the present embodiment, the first locking portion 512 is a sealing portion. As shown in FIG. 10, in the valve-open state, the first locking portion 512 of the seal member 510 and the second locking portion 730 of the ink introduction member 710 are engaged with each other. Specifically, in the valve-open state, the first protruding portion 512p is located inside the groove 731 which is the second locking portion 730. The first protruding portion 512p is deformed by the ink introduction member 710 being inserted into the through hole 519 and comes into contact with the groove 731 over the entire circumference in the circumferential direction. When the first locking portion 512 and the second locking portion 730 are engaged with each other, in the valve-open state, the ink replenishment container 200 is restricted from moving in the second direction D2 relative to the ink introduction member 710. When the first locking portion 512 and the second locking portion 730 are engaged with each other, in the valve-open state, the likelihood that the ink leaks from the ink replenishment container 200 to the outside of the ink introduction member 710 is reduced.

The shape of the first protruding portion 512p in the cross section taken along the central axis C is a semicircular shape. Specifically, the shape in the cross section taken along the central axis C of a portion of the first protruding portion 512p, the portion protruding toward the central axis C beyond the inner circumferential surface located further on the first direction D1 side than the first protruding portion 512p and the inner circumferential surface located further on the second direction D2 side than the first protruding portion 512p , is a semicircular shape. The shape of the first protruding portion 512p in the cross section taken along the central axis C is not limited to the semicircular shape and may be any shape as long as the first protruding portion 512p can be located inside the groove 731 in the valve-open state. In addition, the shape of the groove 731 in the cross section taken along the central axis B of the ink introduction member 710 is not limited to a semicircular shape and may be any shape as long as the first protruding portion 512p can be located inside the groove 731 in the valve-open state.

According to the first embodiment described above, the seal member 510 includes the first locking portion 512, the ink introduction member 710 includes the second locking portion 730, and the first locking portion 512 and the second locking portion 730 are engaged with each other in the valve-open state to restrict the ink replenishment container 200 from moving in the second direction D2 relative to the ink introduction member 710. Therefore, due to the biasing force of the elastic member 530, it is possible to reduce the likelihood that the ink replenishment container 200 moves in a direction away from the ink introduction member 710 of the printer 100 during ink replenishment. Note that the movement of the ink replenishment container 200 in a direction away from the ink introduction member 710 is also referred to as the ink replenishment container 200 floating up. In the present embodiment, since the likelihood that the ink replenishment container 200 floats up during ink replenishment is reduced, the convenience for the user is improved by ensuring the ink replenishment amount, reducing the ink replenishment time, stabilizing the ink replenishment orientation, and the like. In addition, since the first locking portion 512 and the second locking portion 730 are engaged with each other in the present embodiment, the fixing force between the ink replenishment container 200 and the ink introduction member 710 is increased compared to a case where the first locking portion 512 which is a sealing portion of the ink replenishment container 200 comes into close contact with the outer circumferential surface of the ink introduction member 710 which does not have the second locking portion 730. Therefore, it is not necessary for the user to push the ink replenishment container 200 against the ink introduction member 710 during the ink replenishment, and the ink replenishment operation becomes easy.

In addition, in the present embodiment, the first locking portion 512 of the seal member 510 is the first protruding portion 512p which is provided along the circumferential direction of the inner circumferential surface forming the through hole 519 and protrudes toward the central axis C, and the first protruding portion 512p is a sealing portion which comes into contact with the outer circumferential surface of the ink introduction member 710 inserted into the through hole 519 over the entire circumference in the circumferential direction in the valve- open state. In addition, the second locking portion 730 of the ink introduction member 710 is the groove 731 provided over the entire circumference in the circumferential direction on the outer circumferential surface of the ink introduction member 710. The first locking portion 512 of the seal member 510 is also a sealing portion which performs sealing with the ink introduction member 710, and thus has both a function of reducing the likelihood that ink leaks from the ink replenishment container 200 to the outside of the ink introduction member 710 during ink replenishment and a function of reducing the likelihood that the ink replenishment container 200 floats up during the ink replenishment. For this reason, it is possible to simplify the internal structure of the ink replenishment container 200 compared to a case where the first locking portion 512 which engages with the second locking portion 730 is provided separately from a sealing portion which performs sealing with the ink introduction member 710.

In addition, in the present embodiment, the shape in the cross section taken along the central axis C of the first protruding portion 512p which is the first locking portion 512 is a semicircular shape. In addition, the shape of the groove 731 which is the second locking portion 730 in the cross section taken along the central axis B of the ink introduction member 710 is a semicircular shape. Therefore, the engagement between the first locking portion 512 and the second locking portion 730 due to the insertion of the ink introduction member 710 into the ink outlet 460 and the release of the engagement between the first locking portion 512 and the second locking portion 730 due to the removal of the ink introduction member 710 from the ink outlet 460 are smoothly performed.

### B. Second Embodiment:

FIG. 13 is a side view of an ink introduction member 710b in the second embodiment. In the second embodiment, the shape of the ink introduction member 710b is different from that in the first embodiment. The configuration of each portion of the ink replenishment system 10 other than the ink introduction member 710b is the same as that in the first embodiment.

The ink introduction member 710b includes a second locking portion 730b. In the second embodiment, the second locking portion 730b is a protruding portion 732 provided over the entire circumference in the circumferential direction on the outer circumferential surface of the ink introduction member 710b. The shape of the protruding portion 732 in a cross section taken along the central axis B of the ink introduction member 710b is a semicircular shape. Specifically, the shape in the cross section taken along the central axis B of a portion protruding in the direction away from the central axis B from the outer circumferential surface of the ink introduction member 710b in the portion where the protruding portion 732 is not formed is a semicircular shape. The second locking portion 730b engages with the first locking portion 512 of the ink replenishment container 200 when the ink is replenished to the ink reservoir 700 via the ink introduction member 710b. As described above, the first locking portion 512 is the first protruding portion 512p. In the valve-open state, the first protruding portion 512p is located further on the first direction D1 side than the protruding portion 732, and the outer circumferential surface of the first protruding portion 512p and the outer circumferential surface of the protruding portion 732 come into contact with each other over the entire circumference in the circumferential direction. The shape of the protruding portion 732 in the cross section taken along the central axis B of the ink introduction member 710b is not limited to the semicircular shape and may be any shape as long as the portion of the first protruding portion 512p on the second direction D2 side and the portion of the protruding portion 732 on the first direction D1 side can come into contact with the protruding portion 732 over the entire circumference in the circumferential direction in the valve-open state.

According to the second embodiment described above, due to the biasing force of the elastic member 530,it is possible to reduce the likelihood that the ink replenishment container 200 moves in a direction away from the ink introduction member 710b of the printer 100 during the ink replenishment.

### C. Third Embodiment:

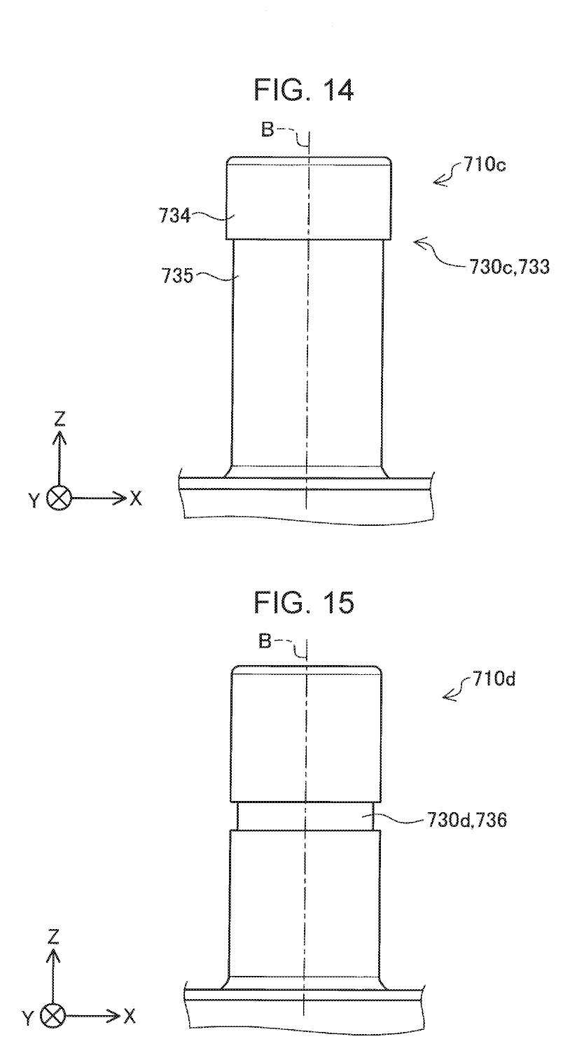

FIG. 14 is a side view of an ink introduction member 710c in the third embodiment. In the third embodiment, the shape of the ink introduction member 710c is different from that of the first embodiment. The configuration of each portion of the ink replenishment system 10 other than the ink introduction member is the same as that in the first embodiment.

The ink introduction member 710c includes a second locking portion 730c. In the third embodiment, the second locking portion 730c is a stepped portion 733 provided over the entire circumference in the circumferential direction onthe outer circumferential surface of the ink introduction member 710c. In the stepped portion 733, the outer diameter of the ink introduction member 710c discontinuously changes so as to be smaller on the -Z direction side than on the +Z direction side. In the example shown in FIG. 14, the outer diameter of the ink introduction member 710c changes discontinuously at one position in the vertical direction. Hereinafter, a portion in which the outer diameter of the ink introduction member 710c has a first radius is referred to as a first portion 734, and a portion in which the outer diameter of the ink introduction member 710c has a second radius smaller than the first radius is referred to as a second portion 735. The second portion 735 is located vertically below the first portion 734. The stepped portion 733 is a portion corresponding to the boundary between the first portion 734 and the second portion 735. The outer diameter of the ink introduction member 710c may discontinuously change at a plurality of positions in the vertical direction so as to be smaller on the -Z direction side than on the +Z direction side. In addition, in the stepped portion 733, the diameter of the ink introduction member 710 may continuously change so as to be smaller on the -Z direction side than on the +Z direction side.

The second locking portion 730c engages with the first locking portion 512 of the ink replenishment container 200 when the ink is replenished to the ink reservoir 700 via the ink introduction member 710c. As described above, the first locking portion 512 is the first protruding portion 512p. In the valve-open state, the first protruding portion 512p is located further on the first direction D1 side than the stepped portion 733 and comes into contact with the stepped portion 733 over the entire circumference in the circumferential direction. When the stepped portion 733 has the shape shown in FIG. 14, the first protruding portion 512p comes into contact with the outer circumferential surface of the second portion 735 over the entire circumference in the circumferential direction, and comes into contact with the lower end of the first portion 734 over the entire circumference in the circumferential direction.

According to the third embodiment described above, due to the biasing force of the elastic member 530, it is possible to reduce the likelihood that the ink replenishment container 200 moves in a direction away from the ink introduction member 710c of the printer 100 during the ink replenishment.

### D. Fourth Embodiment:

In the fourth embodiment, the shapes of an ink introduction member 710d and a seal member 510d are different from those in the first embodiment. The configuration of each portion of the ink replenishment system 10 other than the ink introduction member 710d and the seal member 510d is the same as that in the first embodiment.

FIG. 15 is a side view of the ink introduction member 710d in the fourth embodiment. A second locking portion 730d of the ink introduction member 710d is provided on the outer circumferential surface of the ink introduction member 710d. The second locking portion 730d is a groove 736 provided over the entire circumference in the circumferential direction on the outer circumferential surface of the ink introduction member 710d. The shape of the second locking portion 730d in the cross section taken along the central axis B of the ink introduction member 710d is a rectangular shape. Specifically, the shape in the cross section taken along the central axis B of a portion cut out from the outer circumferential surface of the ink introduction member 710d in the portion where the groove 736 is not formed toward the central axis B is a rectangular shape. The second locking portion 730d engages with the first locking portion 512d of the ink replenishment container 200 when the ink is replenished to the ink reservoir 700 via the ink introduction member 710d.

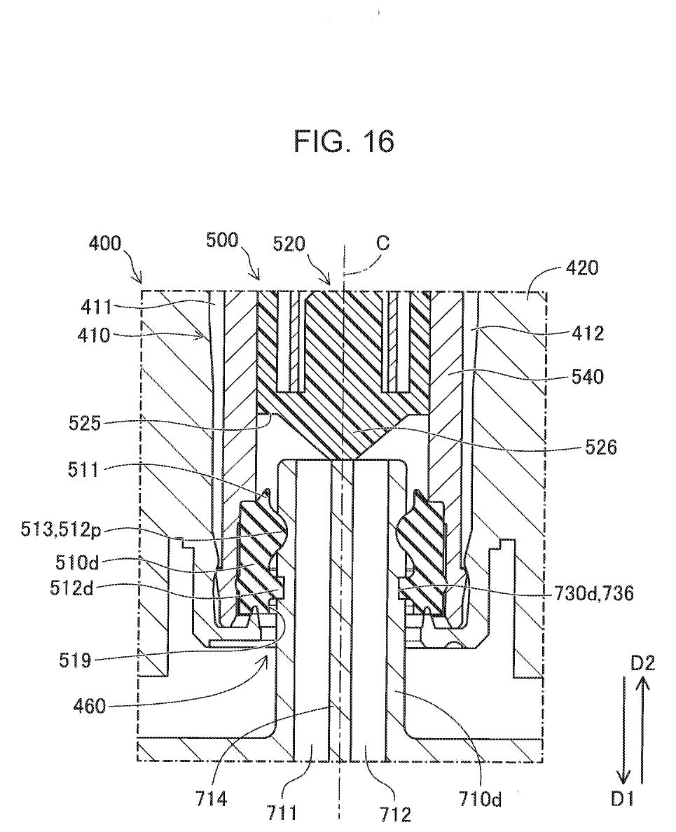

FIG. 16 is a partial cross-sectional view of the ink replenishment container 200 and the ink reservoir 700 in the valve-open state in the fourth embodiment. FIG. 16 shows a cross section of a part of the configuration of the ink replenishment container 200 and a part of the configuration of the ink introduction member 710d when cut along the central axis 0. In the fourth embodiment, the seal member 510d includes the first locking portion 512d and a sealing portion 513. Unlike the first embodiment, the first locking portion 512d and the sealing portion 513 are provided at different portions of the seal member 510d.

The shape of the sealing portion 513 is the same as that of the first locking portion 512 in the first embodiment. That is, the sealing portion 513 is the first protruding portion 512p. The sealing portion 513 is provided along the circumferential direction of the inner circumferential surface forming the through hole 519, protrudes toward the central axis C, and comes into contact with the outer circumferential surface of the ink introduction member 710d inserted into the through hole 519 over the entire circumference in the circumferential direction in the valve-open state. The sealing portion 513 comes into contact with a portion of the outer circumferential surface of the ink introduction member 710d where the second locking portion 730d is not provided. In FIG. 16, the sealing portion 513 and the ink introduction member 710d are illustrated so as to interfere with each other, but in practice, when the ink introduction member 710d is inserted into the tubular portion 420 from the ink outlet 460, the sealing portion 513 is deformed so as to come into contact with the side surface of the ink introduction member 710d.

The first locking portion 512d is a protruding portion provided on the inner circumferential surface of the seal member 510d over the entire circumference in the circumferential direction. The first locking portion 512d is provided on the inner circumferential surface of the seal member 510d at a position different from the sealing portion 513 in the axial direction. In the present embodiment, the first locking portion 512d is provided between the ink outlet 460, which is an outlet facing the outside of the ink replenishment container 200, and the sealing portion 513 in the axial direction. That is, the first locking portion 512d is provided further on the first direction D1 side than the sealing portion 513. In the valve-open state, the first locking portion 512d of the seal member 510d and the second locking portion 730d of the ink introduction member 710d are engaged with each other. Specifically, in the valve-open state, the first locking portion 512d is located inside the groove 736 which is the second locking portion 730d. At least a part of the first locking portion 512d needs to come into contact with the second locking portion 730d, and does not need to come into contact with the second locking portion 730d over the entire circumference in the circumferential direction.

The shape of the first locking portion 512d in the cross section taken along the central axis C is a rectangular shape. Specifically, the shape in a cross section taken along the central axis C of a portion of the first locking portion 512d, the portion protruding toward the central axis C beyond the inner circumferential surface located further on the first direction D1 side than the first locking portion 512d and the inner circumferential surface located further on the second direction D2 side than the first locking portion 512d, is a rectangular shape. The shape of the first locking portion 512d in the cross section taken along the central axis C and the shape of the second locking portion 730d in the cross section taken along the central axis B of the ink introduction member 710d are not limited to a rectangular shape and may be any shape as long as the first locking portion 512d and the second locking portion 730d can be engaged with each other in the valve- open state. For example, the shape of the first locking portion 512d in the cross section taken along the central axis C may be a semicircular shape. Further, the shape of the second locking portion 730d in the cross section taken along the central axis B of the ink introduction member 710d may be a semicircular shape.

According to the fourth embodiment described above, the seal member 510d includes the sealing portion 513 and the first locking portion 512d. The sealing portion 513 is provided along the circumferential direction of the inner circumferential surface forming the through hole 519, protrudes toward the central axis C, and comes into contact with the outer circumferential surface of the ink introduction member 710d inserted into the through hole 519 over the entire circumference in the circumferential direction in the valve-open state. The first locking portion 512d is provided on the inner circumferential surface at a position different from the sealing portion 513 in the axial direction. The second locking portion 730d of the ink introduction member 710d is disposed on the outer circumferential surface of the ink introduction member 710d. Since the sealing portion 513 comes into contact with the outer circumferential surface of the ink introduction member 710d over the entire circumference in the circumferential direction, in the valve-open state, the likelihood that the ink leaks from the ink replenishment container 200 to the outside of the ink introduction member 710d is reduced. In addition to the sealing portion 513 coming into contact with the outer circumferential surface of the ink introduction member 710d, the first locking portion 512d and the second locking portion 730d are engaged with each other. Therefore, compared to a case where the first locking portion 512 also serves as the sealing portion 513 as in the first embodiment, it is possible to further reduce the likelihood that the ink replenishment container 200 moves in a direction away from the ink introduction member 710d of the printer 100 during the ink replenishment. Therefore, the likelihood that the ink replenishment container 200 floats up during the ink replenishment is reduced, and the orientation of the ink replenishment container 200 during the ink replenishment can be held more stably.

In the present embodiment, the first locking portion 512d is provided between the ink outlet 460, which is an outlet facing the outside of the ink replenishment container 200, and the sealing portion 513 in the axial direction. In a case where the sealing portion 513 is provided between the ink outlet 460 and the first lockingportion 512d, that is, in a case where the first locking portion 512d is provided further on the second direction D2 side than the sealing portion 513, there is a possibility that the ink flows into the first locking portion 512d in the valve-open state. On the other hand, in the fourth embodiment, since it is possible to reduce the likelihood that the ink flows out further on the first direction D1 side than the sealing portion 513 in the valve-open state, the ink does not flow into the first locking portion 512d. Therefore, the ink is appropriately replenished to the ink reservoir 700 of the printer 100, and the ink remaining in the vicinity of the seal member 510d after the ink replenishment is completed is reduced.

### E. Other Embodiments

(E-1) In the first embodiment, the first locking portion 512 is the first protruding portion 512p, and the second locking portion 730 is the groove 731 provided over the entire circumference in the circumferential direction on the outer circumferential surface of the ink introduction member 710. On the other hand, the first locking portion 512 may be a groove provided over the entire circumference in the circumferential direction on the inner circumferential surface of the seal member 510, and the second locking portion 730 may be a protruding portion provided over the entire circumference in the circumferential direction on the outer circumferential surface of the ink introduction member 710 and protruding in a direction away from the central axis B.

(E-2) In the fourth embodiment, the first locking portion 512d is a protruding portion provided over the entire circumference in the circumferential direction on the inner circumferential surface of the seal member 510d, and the second locking portion 730d is the groove 736 provided over the entire circumference in the circumferential direction on the outer circumferential surface of the ink introduction member 710d. On the other hand, the first locking portion 512d may be a protruding portion provided on a part of the inner circumferential surface of the seal member 510d in the circumferential direction.

(E-3) In the fourth embodiment, the first locking portion 512d is provided between the ink outlet 460 and the sealing portion 513 in the axial direction. On the other hand, the first locking portion 512d may be provided further on the second direction D2 side than the sealing portion 513 in the axial direction. In other words, the sealing portion 513 may be provided between the ink outlet 460 and the first locking portion 512d in the axial direction.

(E-4) In the fourth embodiment, the second locking portion 730d is the groove 736 provided over the entire circumference in the circumferential direction on the outer circumferential surface of the ink introduction member 710d. On the other hand, the second locking portion 730d may be a protruding portion or a stepped portion provided over the entire circumference in the circumferential direction on the outer circumferential surface of the ink introduction member 710d.

(E-5) In the fourth embodiment, the first locking portion 512d is a protruding portion provided over the entire circumference in the circumferential direction on the inner circumferential surface of the seal member 510d. On the other hand, the first locking portion 512d may be a groove provided over the entire circumference in the circumferential direction on the inner circumferential surface of the seal member 510d. In this case, the second locking portion 730d is a protruding portion provided over the entire circumference in the circumferential direction on the outer circumferential surface of the ink introduction member 710d. The second locking portion 730d may be a protruding portion provided on a part of the outer circumferential surface of the ink introduction member 710d in the circumferential direction.

(E-6) In the fourth embodiment, the first locking portion 512d is a protruding portion provided over the entire circumference in the circumferential direction on the inner circumferential surface of the seal member 510d. On the other hand, the first locking portion 512d may be a stepped portion provided over the entire circumference in the circumferential direction on the inner circumferential surface of the seal member 510d. In this case, the second locking portion 730d is a protruding portion or a stepped portion provided over the entire circumference in the circumferential direction on the outer circumferential surface of the ink introduction member 710d.

(E-7) In the fourth embodiment, the first locking portion 512d is a protruding portion provided over the entire circumference in the circumferential direction on the inner circumferential surface of the seal member 510d. On the other hand, the first locking portion 512d may be a flat surface. Specifically, the inner diameter of the first locking portion 512d may be equal to the inner diameter of a portion of the seal member 510d where the first locking portion 512d is not provided. In this case, the second locking portion 730d is a protruding portion provided over the entire circumference in the circumferential direction on the outer circumferential surface of the ink introduction member 710d.

(E-8) In the fourth embodiment, a groove or the like that engages with the sealing portion 513 may be formed on the outer circumferential surface of the ink introduction member 710d.

### F. Other Aspects:

The present disclosure is not limited to the above-described embodiments, and can be implemented in various forms without departing from the scope of the present disclosure. For example, the present disclosure can also be realized in forms as follows. For example, technical features in the embodiments corresponding to technical features in each aspect described below can be replaced or combined as appropriate to solve some or all of the problems of the present disclosure, or to achieve some or all of the effects of the present disclosure. In addition, unless the technical features are described as essential in the present specification, the technical features can be deleted as appropriate.

(1) A first aspect of the present disclosure provides an ink replenishment system including: a printer including an ink reservoir and an ink introduction member communicating with the ink reservoir; and an ink replenishment container for replenishing ink to the ink reservoir of the printer via the ink introduction member. The ink replenishment container includes: an ink accommodating portion configured to accommodate ink; an ink outlet forming portion in fluid communication with the ink accommodating portion and having an outlet on an opposite side from the ink accommodating portion; and a valve disposed in the ink outlet forming portion, the valve including a seal member located on a side closer to the outlet, a valve body, and an elastic member that biases the valve body toward the seal member in a first direction to bring the valve body into contact with the seal member, wherein, in a valve-open state of the valve, the valve body is pushed in a second direction opposite to the first direction by the ink introduction member inserted into the ink outlet forming portion to be separated from the seal member, and in a valve-closed state of the valve, the valve body comes into contact with the seal member upon the ink introduction member being removed from the ink outlet forming portion, and wherein the seal member has a first locking portion, the ink introduction member has a second locking portion, and the first locking portion and the second locking portion are engaged with each other in the valve-open state to restrict the ink replenishment container from moving in the second direction relative to the ink introduction member.

According to such an aspect, due to the biasing force of the elastic member, it is possible to reduce the likelihood that the ink replenishment container moves in the second direction which is a direction away from the ink introduction member of the printer during the ink replenishment.

(2) In the above aspect, the ink replenishment container may have a central axis, the seal member may have a through hole extending through the seal member in an axial direction along the central axis of the ink replenishment container, the central axis of the ink replenishment container may coincide with a central axis of the through hole, the first locking portion of the seal member may be a first protruding portion that is provided along a circumferential direction of an inner circumferential surface forming the through hole and protrudes toward the central axis of the ink replenishment container, the first protruding portion may be a sealing portion that comes into contact with an outer circumferential surface of the ink introduction member inserted into the through hole over an entire circumference in the circumferential direction in the valve-open state, and the second locking portion of the ink introduction member may be one of a groove, a protruding portion, and a stepped portion provided over the entire circumference in the circumferential direction on the outer circumferential surface of the ink introduction member.

According to such an aspect, it is possible to simplify the internal structure of the ink replenishment container compared to a case where the first locking portion which engages with the second locking portion is provided separately from the sealing portion.

(3) In the above aspect, the ink replenishmentcontainer may have a central axis, the seal member may further include: a through hole that extends through the seal member in an axial direction along the central axis of the ink replenishment container and has a central axis coinciding with the central axis of the ink replenishment container; and a sealing portion that is provided along a circumferential direction of an inner circumferential surface forming the through hole, protrudes toward the central axis of the ink replenishment container, and comes into contact with an outer circumferential surface of the ink introduction member inserted into the through hole over an entire circumference in the circumferential direction in the valve-open state, the first locking portion may be provided on the inner circumferential surface at a position different from the sealing portion in the axial direction, and the second locking portion of the ink introduction member may be provided on the outer circumferential surface of the ink introduction member.

According to such an aspect, since the sealing portion comes into contact with the outer circumferential surface of the ink introduction member over the entire circumference in the circumferential direction and the first locking portion and the second locking portion are engaged with each other, it is possible to further reduce the likelihood that the ink replenishment container moves in the second direction which is a direction away from the ink introduction member of the printer during the ink replenishment, compared to a case where the first locking portion also serves as the sealing portion.

(4) In the above aspect, the first locking portion may be provided between the outlet facing an outside of the ink replenishment container and the sealing portion in the axial direction.

According to such an aspect, it is possible to reduce the likelihood that the ink flows into the first locking portion in the valve-open state.

What is claimed is:

1. An ink replenishment system comprising:
a printer including an ink reservoir and an ink introduction member communicating with the ink reservoir; and
an ink replenishment container for replenishing ink to the ink reservoir of the printer via the ink introduction member,
wherein the ink replenishment container includes:
an ink accommodating portion configured to accommodate ink;
an ink outlet forming portion in fluid communication with the ink accommodating portion and having an outlet on an opposite side from the ink accommodating portion; and
a valve disposed in the ink outlet forming portion, the valve including a seal member located on a side closer to the outlet, a valve body, and an elastic member that biases the valve body toward the seal member in a first direction to bring the valve body into contact with the seal member,
wherein, in a valve-open state of the valve, the valve body is pushed in a second direction opposite to the first direction by the ink introduction member inserted into the ink outlet forming portion to be separated from the seal member, and in a valve-closed state of the valve, the valve body comes into contact with the seal member upon the ink introduction member being removed from the ink outlet forming portion, and
wherein the seal member has a first locking portion, the ink introduction member has a second locking portion, and the first locking portion and the second locking portion are engaged with each other in the valve-open state to restrict the ink replenishment container from moving in the second direction relative to the ink introduction member.

2. The ink replenishment system according to claim 1, wherein
the ink replenishment container has a central axis,
the seal member has a through hole extending through the seal member in an axial direction along the central axis of the ink replenishment container,
the central axis of the ink replenishment container coincides with a central axis of the through hole,
the first locking portion of the seal member is a first protruding portion that is provided along a circumferential direction of an inner circumferential surface forming the through hole and protrudes toward the central axis of the ink replenishment container,
the first protruding portion is a sealing portion that comes into contact with an outer circumferential surface of the ink introduction member inserted into the through hole over an entire circumference in the circumferential direction in the valve-open state, and
the second locking portion of the ink introduction member is one of a groove, a protruding portion, and a stepped portion provided over the entire circumference in the circumferential direction on the outer circumferential surface of the ink introduction member.

3. The ink replenishment system according to claim 1, wherein
the ink replenishment container has a central axis,
the seal member further includes:
a through hole that extends through the seal member in an axial direction along the central axis of the ink replenishment container and has a central axis coinciding with the central axis of the ink replenishment container; and
a sealing portion that is provided along a circumferential direction of an inner circumferential surface forming the through hole, protrudes toward the central axis of the ink replenishment container, and comes into contact with an outer circumferential surface of the ink introduction member inserted into the through hole over an entire circumference in the circumferential direction in the valve-open state,
the first locking portion is provided on the inner circumferential surface at a position different from the sealing portion in the axial direction, and
the second locking portion of the ink introduction member is provided on the outer circumferential surface of the ink introduction member.

4. The ink replenishment system according to claim 3, wherein
the first locking portion is provided between the outlet facing an outside of the ink replenishment container and the sealing portion in the axial direction.
